(19) United States
(12) Patent Application Publication
(10) Pub. No.: US 2004/0231265 A1
(43) Pub. Date: Nov. 25, 2004

(54) Method of forming a molded plywood door skin, molded plywood door skin, and door manufactured therewith

(76) Inventor: John Peter Walsh, St. Charles, IL (US)

Correspondence Address: Joseph W Berenato III, Liniak, Berenato & White, LLC, Suite 240, 6550 Rock Spring Drive, Bethesda, MD, 20817, US

(21) Appl. No.: 10/797,572

(22) Filed: Mar. 11, 2004

Related U.S. Application Data
(60) Provisional application No. 60/454,612, filed on Mar. 17, 2003.

(51) Int. Cl. E06B 3/70; E04C 1/00; E04B 1/00; E04G 21/00

(52) U.S. Cl. 52/455; 52/745.19

(57) ABSTRACT

The present invention relates to a method of molding a plywood board, and plywood board manufactured therefrom, comprising the steps of: providing a plywood board; conditioning the plywood board with water; disposing the conditioned plywood board in a contoured mold press having first and second platens; and deforming the plywood board in the mold press using sufficient heat and pressure to form a molded plywood door skin having contoured portions simulating panels.

### CROSS-REFERENCE TO RELATED APPLICATION AND CLAIM TO PRIORITY

This application is based on provisional application Serial No. 60/454,612, filed Mar. 17, 2003, the disclosure of which is incorporated herein by reference and to which priority is claimed under 35 U.S.C. §120.

### FIELD OF THE INVENTION

The present invention relates to a method of molding a plywood board into a three-dimensional shape suitable for use as a molded door skin. Pursuant to the method, the board is conditioned with water to a predetermined moisture content in excess of the initial or ambient moisture content of the board. The conditioned board is placed into a contoured mold press having a mold cavity. The board is deformed in the mold press under influence of sufficient heat and pressure to form a molded plywood article having contoured portions corresponding to the contour of the mold cavity. The present invention also relates to a molded plywood door skin, and a door having at least one such door skin.

### BACKGROUND OF THE INVENTION

Plywood sheets are well known in the art. Generally, plywood is composed of several wood layers, which are called plies or veneers. The plies are solid wood, and may be formed from a slice or “peel” off a solid wood log. The plies are then bonded together with an adhesive resin and pressed into a flat sheet. The plywood sheet may also include a combination of veneers and a lumber or composite core.

Plywood sheets may be used as door skins, wherein the skins are secured to a peripheral frame as known in the art. Plywood door skins are cheaper than wood composite door skins, and may provide superior strength depending on the number of plies and species of wood used in the plywood.

Plywood door skins may include a higher quality wood veneer that overlays a composite core or plies of lower valued wood. Such plywood door skins are sometimes referred to as luan plywood. Laun refers to a group of high-grade wood species, such as mahogany. Launs are usually bonded to plies of lower grade wood, and provide relatively low structural strength compared to other plywoods, such as fir plywood. As such, luans are often used for making interior doors.

Luan plywood benefits consumers by providing low cost and high quality veneer exterior surfaces. However, luan plywood door skins typically have flat surfaces. Although embossed luan door skins are known in the art, attempts to mold luan or other types of plywood to have contoured features, such as rails, stiles and panels, have not been successful.

Molded wood composite boards that do not include any solid, natural wood plies, such as medium density fiberboard (MDF), chipboard, oriented strandboard (OSB), hardboard, softboard, particleboard, and the like, are well known in the art. Such boards may be molded as door skins. Wood composite door skins may be formed from a relatively thick non-solid mat or bat of material, which is thereafter compressed in a press to a relatively thin, final thickness. The mat can be produced from either dry or wet fibers. If the mat has a very high water content, the water may be squeezed out during the pressing operation. The press may be a multiple platen press, having a series of depressions and protrusions. Because the mat is in a flexible state prior to the pressing operation, the resulting solid skin may have sharply defined features because the wood fibers can be repositioned in order to conform to the mold. However, there are high capital costs involved to build plants to make such molded skins. Manufacturers therefore frequently require that individual orders be for a large number of skins in order to permit maximum operating efficiencies. Smaller orders become cost prohibitive.

A flush door skin may also be formed from the mat of material. Such skins may be made in a similar manner as molded skins, except that the original mat of wood fibers is pressed flat, and is not molded to have contoured portions, such as simulated panels or the like. Although flush skins are relatively inexpensive compared to molded skins having contoured portions, they do not provide the aesthetic features often desired by consumers.

Attempts to reform, or “post-form”, a flat pressed wood composite blank into a molded blank having contoured portions have had varying results. For example, methods for reforming a wood composite blank are disclosed by Moyes in U.S. Pat. Nos. 6,312,540 and 6,079,183, the disclosures of which are incorporated herein by reference and the assignee of which is the assignee hereof. Wood composite blanks are comprised of reconstituted wood fibers that have been broken down into small wood chips and/or wood fiber particles. These particles are bonded together with a synthetic resin to form the composite blank. During post-forming, the resin and particles comprising the wood composite board are softened using heat and moisture. The fiber particles and resin may then be repositioned to the desired contoured configuration.

When reforming flat wood composite blanks, it is generally preferable that the flat board be comprised of relatively small wood fiber particles since the particles must be repositioned. Flat composite boards having relatively small wood fiber particles are easier to reform than composite boards having larger wood fiber particles. Generally, as the size of the wood fiber particles decreases, the surface quality of the reformed article increases. For this reason, post-forming quality and performance decrease from MDF to chipboard to OSB, which contain wood fiber particles that are increasingly large, respectively.

Reformed wood composite boards formed from wood composites, such as MDF, chipboard, OSB, hardboard, softboard, and particleboard, (i.e. wood composites that do not include a solid, natural wood ply as in plywood) provide some advantages over standard molded articles and flush articles that have been formed from the non-solid mat of material. For example, reformed wood composite skins are much less expensive to manufacture compared to standard molded skins. However, the resulting surface quality of such wood composite articles lacks the appearance of natural wood, especially the color, grain and/or knot patterns that are considered desirable by many consumers. If a natural appearance is desired, a wood veneer, paper overlay or foil may be bonded to the surface of the article. However, the application of veneers, papers and foils is often time consuming, and, especially in the case of papers and foils, can produce an unacceptable product if great care is not taken in the application of the materials. This increases the manufacturing cost of such articles.

Plywood has exteriorly disposed layers or plies that are natural, solid wood. Therefore, plywood provides the qualities and appearance of a solid piece of wood. However, because of the structure and properties of the solid wood layers, conventional methods of reforming plywood have failed to achieve commercially acceptable products. The wood fibers in the solid wood plies have not been disrupted or reduced in size, such as with wood fiber particles in wood composite boards. In addition, the wood fibers in the solid plies of plywood are bonded together with a natural wood binder, lignin. Lignin bonds natural wood fibers together to form the wood grain. However, lignin does not display the same reforming capabilities compared to the synthetic resin used to bond the wood particles together in wood composite boards. Lignin may not be softened and repositioned in the same manner as synthetic resin. As such, moldability of plywood is substantially decreased.

Attempts to reform plywood have failed due to the natural properties of the solid wood layers comprising plywood (i.e. the wood fiber structure and size as well as the properties of lignin). Such attempts have resulted in plywood boards having cracked and/or marred surfaces, particularly in contoured portions of the surface that are perpendicular to the direction of the wood grain. In comparison, wood composite boards, though not perfectly isotropic, may be more easily molded due to the relatively small size of its wood particles as well as the properties of the synthetic resin used to bond the particles together. Lignin present in the wood particles used in wood composite boards is disrupted during initial wood fiber particle size reduction. Therefore, it does not materially affect conventional reforming processes of such wood composite boards.

Therefore, there is a need for a method of reforming plywood boards to have a contoured surface, such as with reformed wood composite articles, which will provide the surface qualities and appearance of natural wood.

### SUMMARY OF THE INVENTION

The present invention relates to a method of molding a plywood board, comprising the steps of: providing a plywood board; conditioning the plywood board with water; disposing the conditioned plywood board in a contoured mold press having a mold cavity; and deforming the plywood board in the mold press using sufficient heat and pressure to form a molded plywood door skin having contoured portions corresponding to the mold cavity that simulate at least one panel.

A molded plywood door skin manufactured therefrom is also disclosed. A molded plywood door skin comprises a molded plywood substrate having at least one panel portion, a molded depression surrounding and integral with the panel portion, and an outer portion surrounding and integral with the molded depression.

A door comprises first and second door skins, each door skin having an interior surface secured to a peripheral door frame and an exterior surface. At least one of the door skins is a molded plywood door skin having at least one panel portion, a molded depression surrounding and integral with the panel portion, and an outer portion surrounding and integral with the molded depression.

### BRIEF DESCRIPTION OF THE FIGURES

FIG. 1 is a perspective view of a molded multi-layer door skin according to the present invention;

FIG. 2 is an exploded fragmentary view of portion 2-2 circled in FIG. 1;

FIG. 3 is a fragmentary cross-sectional view of line 3-3 in FIG. 1 viewed in the direction of the arrows;

FIG. 4 is a schematic view of a conditioning chamber and press according to the present invention;

FIG. 5 is an exploded, fragmentary cross-sectional view of the press in FIG. 4; and

FIG. 6 is a perspective view of a door having a molded multi-layer door skin.

### DETAILED DESCRIPTION OF THE INVENTION

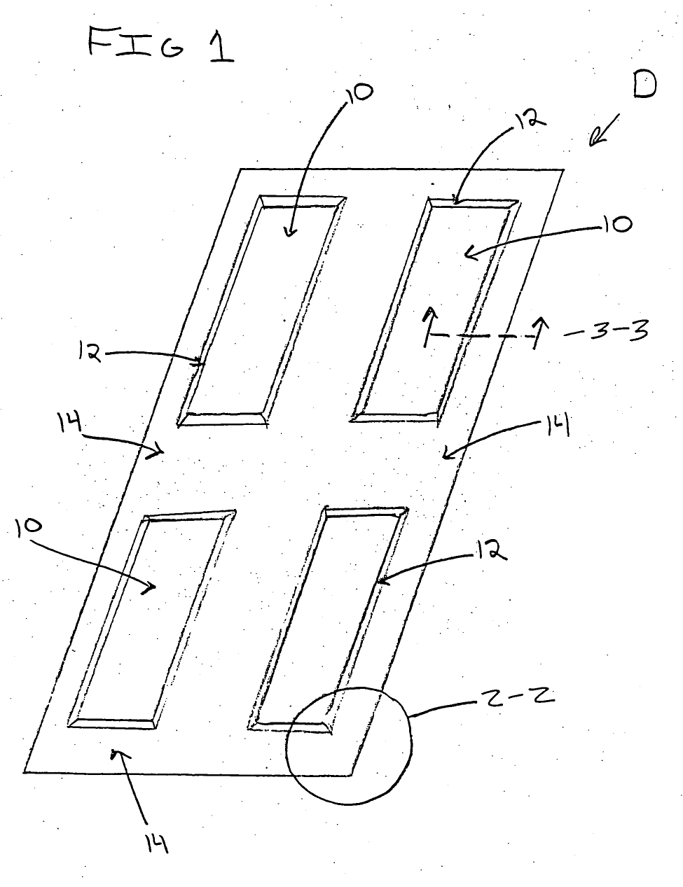

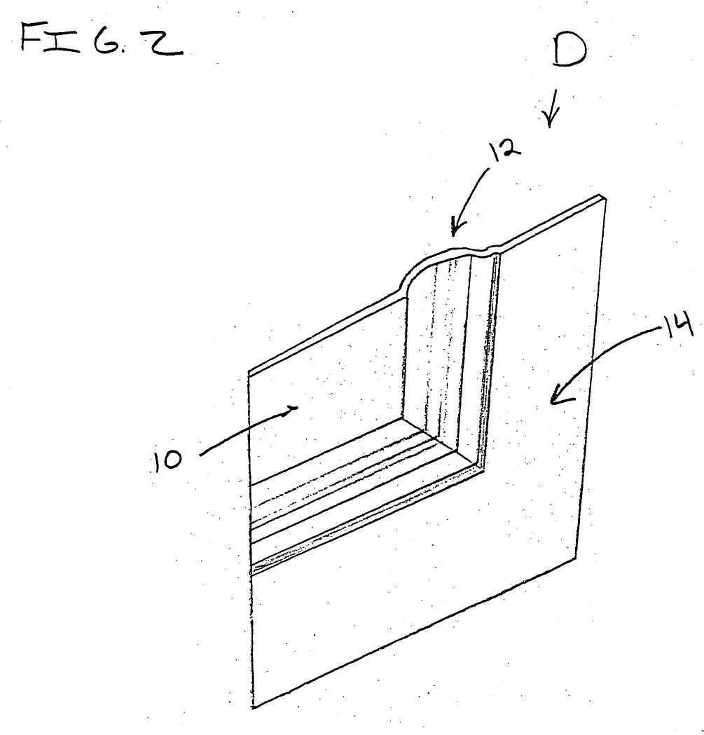

As best shown in FIGS. 1-3, the present invention is directed to a molded plywood door skin D having an exterior surface 2 and an interior surface 4, and at least one panel portion 10. A molded depression 12 surrounds and is integral with panel portion 10. An outer portion 14 surrounds and is integral with molded depression 12.

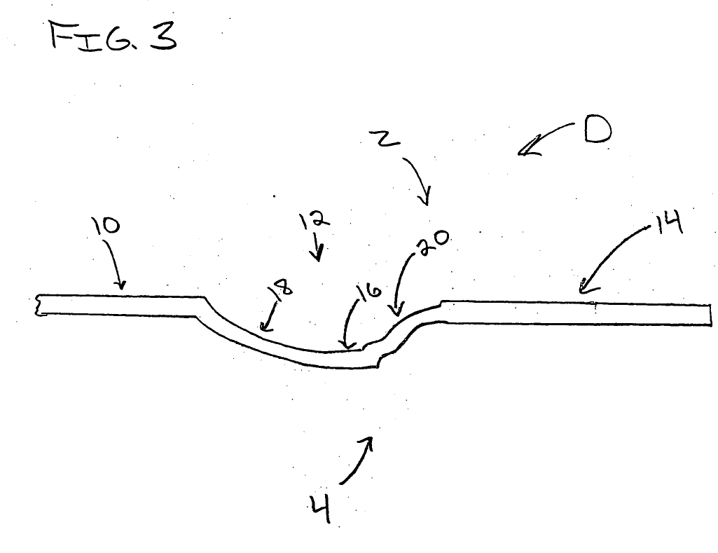

As best shown in FIG. 3, molded depression 12 is preferably formed to have a depression base 16 that is recessed from the plane of outer portion 14 from between about 6 mm to about 9 mm. Panel portion 10 is preferably coplanar with outer portion 14. However, it should be understood that panel portion 10 may also lie on a plane that is spaced from the plane of outer portion 14. Molded depression 12 may include an inclined wall 18 extending from base 16 to panel portion 10, and a contoured portion 20 extending from base 16 to outer portion 14.

Preferably, molded plywood door skin D is formed from a luan plywood board. The luan plywood board used to form multi-layer door skin D includes a high-grade solid, natural wood ply, which provides a wood grain pattern on exterior surface 2. Preferably, luan plywood having a thickness of between about 2.5 millimeters (mm) to about 4.0 mm is used.

Other types of plywood may also be used to form molded plywood door skin D. As used herein, the term plywood includes any multi-layer substrate having an exteriorly disposed solid, natural wood ply, such as a veneer. The plywood may include more than solid wood plies. Alternatively, the plywood may include only one solid wood ply, or veneer, preferably forming exterior surface 2 of door skin D. The plywood may also include one or more composite core layers. The core layer(s) may be formed from a wood composite, such as MDF, chipboard, OSB, hardboard, soft board, or particleboard. The solid, natural wood layer is bonded to the core layer(s) to form a plywood board B. For example, an exterior layer of veneer may be bonded to a wood composite substrate, such as MDF, to form plywood board B.

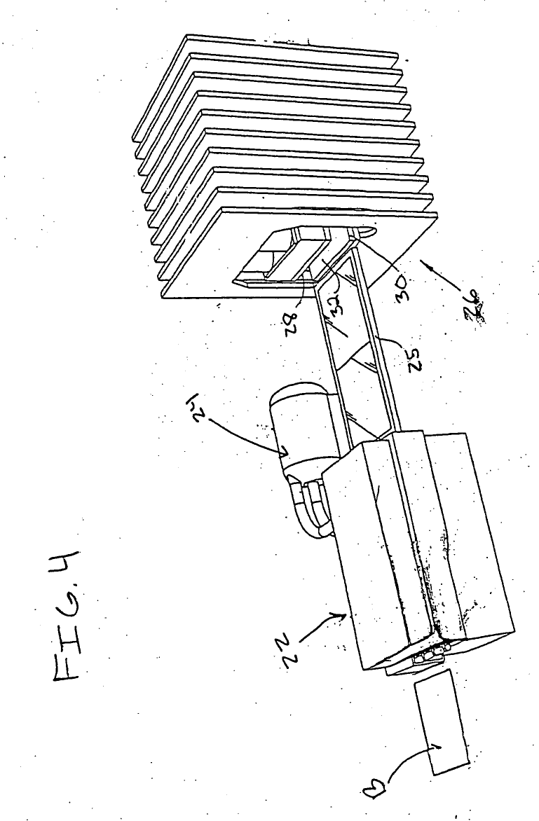

As best shown in FIG. 4, plywood board B is first subjected to a conditioning step in a chamber 22, wherein board B is heated and treated with steam generated by a boiler 24 to increase moisture content of board B, thereby softening the plies and resin of board B. Preferably, plywood board B has an initial water content of about 7% prior to conditioning. However, it should be understood that different types of plywood may have different initial water contents.

Various methods of conditioning board B may be used. The plywood may be exposed to steam in an atmospheric (i.e. non-pressurized) chamber.

Alternatively, the plywood may be exposed to steam in a pressurized, sealed steam injection cavity. Preferably, the plywood is exposed for about 30 minutes in a pressurized cavity having a steam pressure of about 100 psi. Alternatively, the plywood may be soaked in a water bath, or exposed to surface water sprays. The preferred soaking time is between about 4 hours and about 24 hours. Surfactants may also be used to achieve the desired moisture pick-up. For example, the plywood may be soaked in a water-surfactant bath for between about 4 hours and about 24 hours, wherein the bath comprises water and about 0.2% Rhodasurf surfactant.

In any case, the plywood board B is conditioned through the use of water and heat in chamber 22 until moisture content of the board B has increased to a moisture content of between about 10% to about 40%, depending on the depth of molded depression 12 to be achieved during the molding process, as well as the type of plywood being reformed.

The thermal softening point of the plywood board is a function of the wood species comprising the plies of the plywood board, the initial cellular moisture content of the wood species, and the chemical properties of the resin adhering the plies together. As such, the amount of heat and water required in chamber 22 to increase the moisture content to the preferred range is variable. Softening at as low a temperature as possible is preferred.

After board B has been conditioned in chamber 22, board B is forwarded via a conveyor 25 to a deforming press 26. As known in the art, press 26 includes upper and lower platens 28, 30, which define in the closed state of press 26 a contoured mold cavity 32. The heated, moistened board B is then pressed into a molded shape using a relatively slow, continuous closure rate of press 26. Preferably, the closure rate of press 26 is about 3 mm per minute to about 7 mm per minute, more preferably about 5 mm per minute. Press 26 preferably applies between about 100 psi to about 500 psi to moistened board B during compression. In addition, platens 28, 30 are heated to create a temperature in mold cavity 32 of between about 350° F. and 450° F., preferably about 400° F. The softened board is thereby deformed using heat and pressure in press 26. However, the preferred pressure and temperature ranges disclosed herein are not dependent on the closure rate of press 26. As such, different pressure and temperature ranges may be appropriate depending on the type of plywood species being molded. The slow closing rate of about 5 mm per minute is preferably maintained regardless of the pressure and temperature associated with press 26.

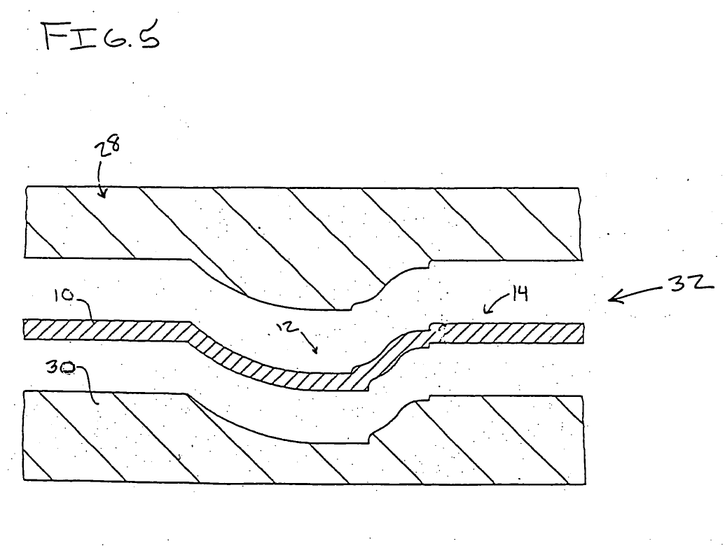

Water is driven from the plywood board during deformation, whereby excess steam is permitted to escape due to the relatively slow closure rate of press 26. The resulting plywood door skin D is formed to have a contoured shape corresponding to contoured mold cavity 32, as best shown in FIG. 5. Preferably, plywood door skin D is compressed to a final thickness of between about 2.0 mm to about 4 mm. The post-formed plywood door skin D has a substantially uniform thickness, as well as a substantially uniform density.

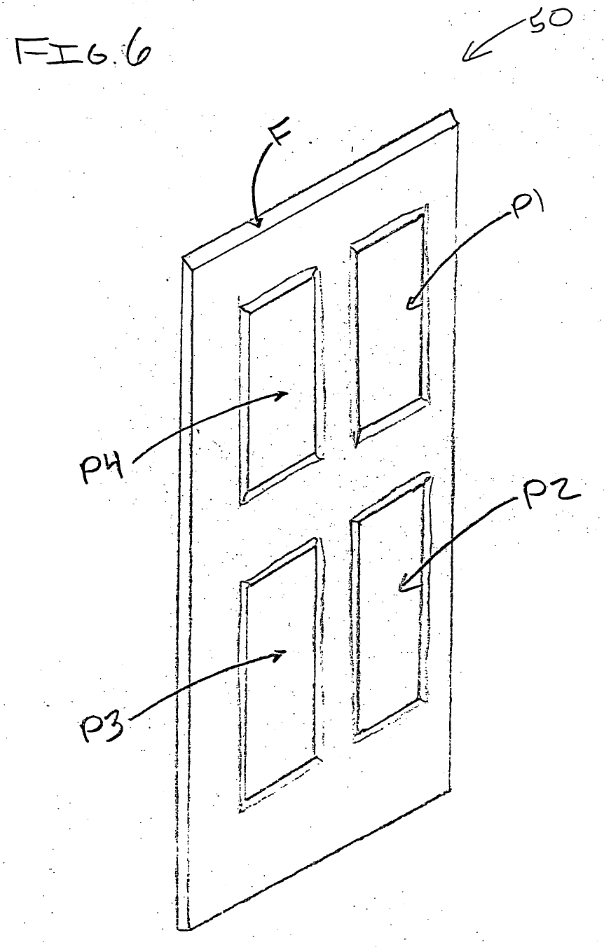

As best shown in FIG. 6, the present invention is also directed to a door 50 having a peripheral interior frame F, as known in the art, and first and second door skins. At least one of the door skins is a molded plywood door skin D, as disclosed above. Thus, door skin D includes at least one panel portion 10, but may include multiple panel portions 10. For example, door 50 has four panel portions 10, forming panels P1, P2, P3 and P4. Each of molded panels P1-P4 includes a panel portion 10, a depression 12 and outer portion 14, as described above.

It will be apparent to one of ordinary skill in the art that modifications and variations can be made in construction or configuration of the present invention without departing from the scope or spirit of the invention. Therefore, it is intended that the disclosed invention cover all such modifications and variations, provided they come within the scope of the following claims and their equivalents.

What is claimed is:

1. A method of forming a molded plywood door skin, comprising the steps of:
providing a plywood board;
conditioning the plywood board with water;
disposing the conditioned plywood board in a contoured mold press having a mold cavity; and
deforming the plywood board in the mold press using sufficient heat and pressure to form a molded plywood door skin having contoured portions corresponding to said mold cavity.

2. The method of claim 1, including the step of closing the mold press at a predetermined closure rate.

3. The method of claim 2, wherein the predetermined closure rate is between about 3 mm per minute and about 7 mm per minute.

4. The method of claim 1, wherein said conditioning step includes exposing the plywood board to steam in an atmospheric chamber.

5. The method of claim 1, wherein said conditioning step includes exposing the plywood board to steam in a pressurized, sealed cavity.

6. The method of claim 5, wherein the plywood board is exposed to steam in the pressurized, sealed cavity for at least about 30 minutes during said conditioning step.

7. The method of claim 1, wherein said conditioning step includes soaking the plywood board in a water bath.

8. The method of claim 7, wherein the plywood board is soaked in the water bath for at least about 4 hours during said conditioning step.

9. The method of claim 1, wherein said conditioning step includes exposing the plywood board to a surface spray.

10. The method of claim 9, wherein said conditioning step further comprises using surfactants to achieve a desired moisture pick-up.

11. The method of claim 1, wherein said conditioning step increases moisture content of the plywood board to between about 10% and about 40%.

12. The method of claim 1, wherein the plywood board is a luan plywood board.

13. The method of claim 1, wherein the plywood board includes an exterior ply of solid natural wood, and at least one interior core layer.

14. The method of claim 13, wherein the interior core layer is selected from the group consisting of medium density fiberboard, chipboard, oriented strandboard, softboard, hardboard, and particleboard.

15. A molded multi-layer door skin, comprising:
a molded plywood substrate having at least one panel portion;
a molded depression surrounding and integral with said panel portion; and
an outer portion surrounding and integral with said molded depression.

16. The door skin of claim 15, wherein said molded depression comprises an inclined wall extending downwardly from said panel portion to a depression base.

17. The door skin of claim 16, wherein said molded depression further comprises a contoured portion extending from said depression base to said outer portion.

18. The door skin of claim 16, wherein said depression base is recessed from the plane of said outer portion between about 6 mm to about 9 mm.

19. The door skin of claim 15, wherein the plywood door skin has a thickness of between about 2 mm to about 4 mm.

20. The door skin of claim 15, wherein said panel portion and said outer portion are coplanar.

21. The door skin of claim 15, wherein the plywood skin is formed from luan plywood.

22. The door skin of claim 15, wherein said plywood comprises an exterior solid, natural wood ply and at least one core layer.

23. The door skin of claim 22, wherein said core layer is formed from a wood composite selected from the group consisting of medium density fiberboard, oriented strand board, chipboard, hardboard, soft board, and particleboard.

24. A door, comprising:
first and second door skins, each door skin having an interior surface secured to a peripheral door frame and an exterior surface, at least one of said door skins being a molded plywood door skin having at least one panel portion, a molded depression surrounding and integral with said panel portion, and an outer portion surrounding and integral with said molded depression.
